(19) United States
(12) Patent Application Publication
(10) Pub. No.: US 2009/0080377 A1
(43) Pub. Date: Mar. 26, 2009

(54) Distributed Channel Management Based on Channel Hopping in Uncoordinated 802.11 Based WLAN

(75) Inventors: Samrat Ganguly, Monmouth Junction, NJ (US); Vishnu Navda, Bangalore (IN); Aniruddha Bohra, Edison, NJ (US); Daniel S. Rubenstein, New York, NY (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/860,104

(22) Filed: Sep. 24, 2007

(51) Int. Cl. H04Q 7/00

(52) U.S. Cl. 370/329

(57) ABSTRACT

In accordance with the invention, a method includes i) obtaining first for each AP hopping sequences of other interfering APs; and ii) determining for the AP a respective hopping sequence that maximizes each APs throughput. Preferably, the step of determining comprises for each slot AP choosing a channel that minimizes the number of edges which violate a k-coloring property. In an exemplary embodiment, the method further includes the step of the AP selecting one of (a) a channel uniformly at random from all such channels and (b) selecting a channel that distributes interference evenly as possible among neighboring APs.

This application claims the benefit of U.S. Provisional Application No. 60/825,281, entitled “Distributed Channel Management in Uncoordinated 802.11 Based WLAN”, filed on Oct. 19, 2006, the contents of which is incorporated by reference herein.

### BACKGROUND OF THE INVENTION

The present invention relates generally to wireless local area networks, and, more particularly, to a distributed channel management in uncoordinated 802.11 based wireless local area network WLAN.

The following works by others are mentioned in the application and referred to by their associated reference:
[1] A. Akella, G. Judd, S. Seshan, and P. Steenkiste, “Self management in chaotic wireless deployments,” in ACM Mobicom, 2005.
[2] A. Balachandran, G. Voelker, and P. Bahl, “Wireless hotspots: Current challenges and future directions,” in ACM WMASH, 2003.
[3] Y. Bejerano, S. Han, and L. Li, “Fairness and load balancing in wireless lans using association control,” in ACM Mobicom, 2004.
[4] A. Mishra, V. Brik, S. Banerjee, A. Srinivasan, and W. Arbaugh, “A client-driven approach for channel management in wireless lans,” in IEEE Infocom, 2006.
[5] A. Vasan, R. Ramjee, and T. Woo, “Echos: Enhanced capacity 802.11 hotspots,” in IEEE Infocom, 2005.
[6] P. Bahl, R. Chandra, and J. Dunagan, “Ssch: Slotted seeded channel hopping for capacity improvement in ieee 802.11 ad hoc wireless networks,” in ACM Mobicom, 2004.
[7] “Intel pro/wireless network connection for mobile,” http://www.intel.com/network/connectivity/products.
[8] A. Mishra, E. Rozner, S. Banerjee, and W. Arbaugh, “Exploiting partially overlapping channels in wireless networks: Turning a peril into an advantage,” in ACM/USENIX IMC, 2005.
[9] J. Geier, “Assigning 802.11b access point channels,” Wi-Fi Planet, 2004.
[10] C. McDiarmid and B. Reed, “Channel assignment and weighted coloring,” Wiley Networks, 2000.
[11] G. B. Sabbatel, A. Duda, M. Heusse, and F. Rousseau, “Shortterm fairness of 802.11 networks with several hosts,” in IEEE MWCN, 2004.
[12] A. Blum, “New approximation process for graph coloring,” JACM, 1994.
[13] “Wigle: Wireless geographic logging engine,” http://www.wigle.net/.
[14] A. Mishra, S. Banerjee, and W. Arbaugh, “Weighted coloring based channel assignment for wlans,” Mobile Computer Communications Review (MC2R), vol. 9, no. 3, 2005.
[15] T. Rappaport, Wireless Communications: Principle and Practice, Prentice Hall, 1996.
[16] B. Krishnamachari S. Wicker, R. Bejar, and C. Fernandez, “On the complexity of distributed self-configuration in wireless networks,” Telecommunication Systems, 2003.
[17] M. Alicherry, R. Bhatia, and L. Li, “Joint channel assignment and routing for throughput optimization in multi-radio wireless mesh networks,” in ACM MobiCom, 2005.
[18] M. Kodialam and T. Nandagopal, “Characterizing the capacity region in multi-radio, multi-channel wireless mesh networks,” in ACM MobiCom, 2005

Wireless hotspots have grown rapidly as a customary attraction at restaurants, cafes and shops. Such wireless networks are typically small in size (often, a single AP) and are independently owned and managed. Such uncoordinated installations often manifest themselves in highly variable AP densities in many urban areas. For these reasons, we refer to them as ‘uncoordinated’ wireless deployments (also referred to as ‘chaotic’ networks by Akella et. al. in [1]) to distinguish them from ‘centralized’ deployments typically found in offices and campus buildings. The uncoordinated nature of hotspots has led to unsatisfactory and unpredictable network performance for its clients.

Uniqueness of uncoordinated deployments: This application primarily focuses on the fairness problem in uncoordinated deployment scenarios. While association control approaches (such as [2], [3], [4]) are particularly attractive to achieve fairness goals in centralized deployments, they are not feasible in uncoordinated deployment for the following reason. Clients of a given AP (from one hotspot, say a coffee-shop) may not be authorized to connect to another AP (of a neighboring hotspot, say a nearby restaurant). In particular, the model of uncoordinated deployment poses a few other constraints on the nature of the problem as well as the solutions that are practical. They are:

(a) It is not possible to improve client performance in this environment through careful AP placement or site surveys, an approach which is quite commonly employed for WLAN deployments in offices.

(b) The proposed solution should be simple, i.e., require minimal to zero coordination between APs or their clients. This is because the APs and their clients are effectively in different management domains and may have no explicit way of interacting with one another.

(c) We posit that the desired notion of fairness in uncoordinated deployments is fairness aggregated at the AP level and not at the level of individual clients. Essentially if two APs (1 and 2) are in close proximity of each other, then we call the performance perfectly fair if the aggregated throughput of all clients of AP1 is identical to the aggregated throughput of all clients of AP2. We make this hypothesis due to the following two reasons, one philosophical and the other practical: (i) 802.11 hotspots operate in unlicensed bands and hence, in absence of explicit market mechanisms, no hotspot should have greater priority on the total bandwidth over another, irrespective of the number of clients, and (ii) Providing proportional fairness in these environment is certainly possible if APs (and their clients) estimate relative client set sizes of nearby APs. However, these mechanisms will require additional coordination between APs/clients across different management domains, which is not too practical. A specific danger of empowering APs with specific control knobs over its fair share is that it may itself escalate selfish behavior in the environment, requiring more complex game-theoretic formulations and solutions. In the rest of the paper, we therefore, focus on the AP-level fairness problem, as relevant to uncoordinated deployments.

There are multiple complementary ways of addressing performance issues in 802.11 networks, as summarized in FIG. 1. First is power control. Proper management of transmit power reduces interference and improves network performance on the whole. Akella et. al. [1] propose a dynamic power management technique to reduce interference in chaotic deployments, while the Echos system [5] uses careful carrier sense mechanisms at the receiver to eliminate unnecessary interference. A second, is to perform careful assignment of wireless channels to mitigate interference among neighboring APs, e.g., LCCS (described later in this paper). A third approach is to use association control which balances client-load across a set of APs [2], [3], [4]. However, as pointed out, this approach is not applicable in the context of uncoordinated deployments of APs.

Given prior work along the power control (and carrier sensing) dimension of performance optimization in uncoordinated deployments, it is natural to next examine the complementary dimension of channel assignment both in isolation, and in tandem, which is the focus of our paper. While fairness is our primary metric in this work, we also examine the (positive) impact of our proposed mechanisms on the aggregate throughput metric as well.

The following are some of the key components of this work: Channel Hopping, Switching Overhead, Impact on TCP, Partially Overlapped Channels and Client Driven Assignment.

Channel Hopping. In this application, we explore the idea of channel hopping for improving fairness. APs spend a fixed amount of time on a single channel, called a slot and switch to a subsequent channel as given by its hopping sequence. All clients associated to an AP switch channels along with it. The specific channel hopping process proposed in this paper, called MAXchop, is easy to implement through trivial extensions to existing client-AP synchronization mechanisms that are already available in the 802.11 standard.

The technique of channel hopping allows the network as a whole to timeshare between different static channel assignments. In this manner, no single AP suffers for long due to an unfavorable channel assignment. Intuitively, this improves fairness over the throughputs obtained from each individual channel assignment. It is this property of channel hopping that we bring into focus in this paper and show that it can provide significant improvement in fairness over existing channel assignment mechanisms for uncoordinated deployments.

We note that in [6], Bahl et. al. propose a protocol called SSCH, that uses channel hopping for capacity improvement in a wireless ad-hoc network where nodes have a single interface. In their work, channel hopping allowed nodes operating on different channels to synchronize due to overlap in their hopping sequences and yet utilize multiple non-overlapping channels for improved network throughput. In contrast, this invention in the context of uncoordinated deployments of 802.11 WLANs, is the first that explicitly exposes the fairness properties of channel hopping techniques. The different end goals of SSCH and MAXchop, imply that the specific channel-hopping process in the two cases are necessarily different. The fact that channel hopping can improve fairness in a fully distributed manner over some good centralized techniques is the central idea explored in this paper, that we hope will be employed by future research in other wireless domains.

Switching Overhead. Channel hopping requires APs and associated clients to switch channels at the end of a slot which has an overhead associated with it. Common wireless hardware takes about 6-20 ms to switch to a different channel based on our measurements. This latency goes into initializing the radio and synchronizing with the new channel at the physical layer. We amortize this cost by reducing the frequency of channel hopping, that is, by increasing the duration of a single slot. For example, by using a slot period of one second or more, this amortizes the channel switch overhead over a large number of packets, such as a thousand data packets over one second assuming 11 Mbps data-rate and 1024 bytes per packet. We also note that emerging wireless cards such as Intel's Pro-Wireless [7], report a channel switch latency of under 100 μs which greatly reduces the overhead of implementing channel hopping. Through an implementation over commercial hardware, we show that the practical overheads of channel hopping are minimal and far outweigh its gains.

Impact on TCP. Channel switching can have a negative impact on TCP performance. This is because occasional packet losses while switching channels, can affect TCP's congestion window thereby reducing throughput momentarily. The application addresses this issue as follows: (i) Channel switching is triggered by an AP during relatively low periods of activity to minimize packet losses, and (ii) channel switching is performed at a low frequency thereby reducing the overall impact of channel hopping on TCP. A slot period of one second ensures that such losses are infrequent. Through our evaluation in Sections VI and VII, we show that these techniques have negligible adverse effects on TCP performance.

Partially Overlapped Channels. The popular 2.4 GHz band provides for only three non-overlapping channels which are insufficient for dense wireless hotspots. Recent work [8] has shown that by careful measurement and modeling interference among the 11 “partiallyoverlapped” channels along with careful channel assignment and coordination between interfering APs it is possible to achieve significant improvement in performance. Such an approach would normally be difficult in uncoordinated deployments. It turns out that the specific nature of the proposed channel hopping approach is a very effective way to leverage partially overlapping channels in uncoordinated deployments with zero coordination, which otherwise would require significant coordination and planning.

Client-driven Assignment. Prior work [4] has shown that client participation in estimating interference is crucial in finding APs that are ‘hidden’ and yet interfere at clients positioned unfavorably.

Prior work by Akella et. al. in [1], the Echos system [5] and the SSCH protocol by Bahl et. al. [6] have been discussed before. There has been much recent work in improving client throughputs in the context of centrally managed wireless LANs. Work by Bejerano et. al [3] presented a centralized linear program (LP) based formulation of balancing client load among APs using association control. Work by Balachandran et. al. [2] discuss a network-driven method for providing hints to users. These hints are used to improve the quality of service experienced by a user by, for example, requesting them to roam to a better provisioned AP. The CFAssign methods in [4] address the joint problem of channel assignment and load balancing in centrally managed WLANs. The application shows that client-driven mechanisms are important in capturing interference accurately. By comparing against prior vertex coloring based approaches [14] the application also shows that vertex coloring approaches tend to be inefficient for centrally managed WLANs. The scope and nature of their problem is much different than that of uncoordinated wireless environments. Apart from wireless LANs, there has been much work on channel assignment process in the context of cellular networks [15], [16] and wireless mesh networks and other references of interest include [17], [18] and the references therein.

Accordingly, given that the uncoordinated nature of hotspots has led to unsatisfactory and unpredictable network performance for its client there is a need for a method for distributed channel management.

### SUMMARY OF THE INVENTION

In accordance with the invention, a method includes i) obtaining first for each AP hopping sequences of other interfering APs; and ii) determining for the AP a respective hopping sequence that maximizes each APs throughput. Preferably, the step of determining comprises for each slot AP choosing a channel that minimizes the number of edges which violate a k-coloring property. In an exemplary embodiment, the method further includes the step of the AP selecting one of (a) a channel uniformly at random from all such channels and (b) selecting a channel that distributes interference evenly as possible among neighboring APs.

In another aspect of the invention, a method includes the steps of i) initializing channel assignment with a pseudo-random hopping sequence; ii) determining interferences between APs for each said channel assignment, and iii) determining a color/channel that divides interferences equally among interfering APs out of a set of colors that provide best throughput for a given AP. Preferably the initializing is executed at an AP during one of bootup and periodically after a given period of time. Also, the step i) initializing includes re-intializing the state maintained by the method after a given period of time. Preferably, the step ii) of determining includes being done at the end of a hopping period.

### BRIEF DESCRIPTION OF DRAWINGS

These and other advantages of the invention will be apparent to those of ordinary skill in the art by reference to the following detailed description and the accompanying drawings.

FIG. 1 is a diagram illustrating complementary methods of improving 802.11 performance, including channel based on channel hopping, in accordance with the invention.

FIG. 2 is a diagram of (a) hidden AP problem in LCCS, (b) an example topology and (c) its hopping sequence.

FIG. 3 is a diagram of a process utilizing channel hopping along with information about the hopping sequences in a distributed manner, in accordance with the invention.

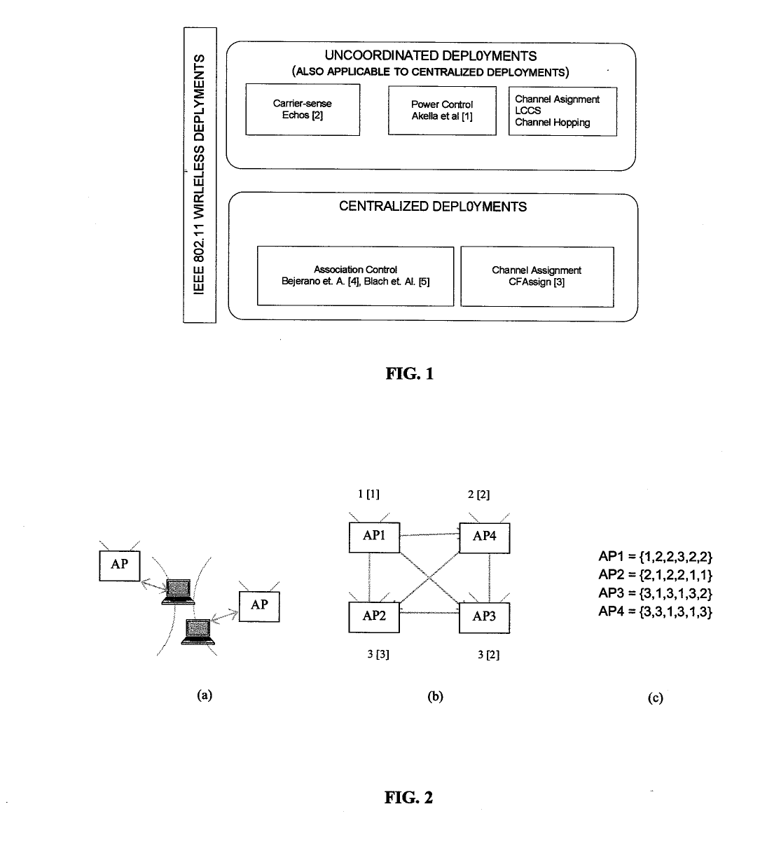

### DETAILED DESCRIPTION

The invention is directed to the fairness problem for uncoordinated 802.11 wireless deployments. This problem is analyzed from the channel assignment perspective and the inventive solution is based on the notion of channel-hopping. The invention meets all the important design considerations for control methods in uncoordinated deployments—distributed in nature, minimal to zero coordination among APs belonging to different hotspots, simple to implement, and interoperable with existing standards. In particular, the invention includes a process which works efficiently when using only non-overlapping wireless channels, but is particularly effective in exploiting partially-overlapped channels that have been proposed in recent literature. Simulations on real hotspot topologies and evaluation of a full implementation of this technique support the efficacy of the invention for not only fairness, but also the aggregate throughput, metrics.

Wireless hotspots are typically implemented using 802.11 APs. Each AP typically operates on a single, administrator-configured wireless channel. Each client associates with a single AP and subsequently interacts with this AP alone, on the AP's configured channel. As a basic design rule, APs within radio frequency (RF) range of each other are set to different ‘nonoverlapping’ channels. Proper assignment of channels to APs is important so that the network can take full advantage of the total wireless bandwidth offered by the multiple channels.

Channel Assignment Approaches. Most APs are initialized for their channel of operation through manual input. This is inefficient as it is based on human judgment of which channel is the best. Apart from this, some AP vendors implement a simple distributed method commonly called the least congested channel search (LCCS) process [9]. In LCCS, upon initialization, the AP scans and selects the channel that offers the least amount of congestion, for example, the channel on which there was least amount of traffic belonging to other APs and clients. Since in LCCS, APs perform a scan without involving client feedback, it is possible that two APs might not detect each other and utilize the same channel. As a result, it is possible for clients to be positioned unfavorably so as to suffer considerable interference as a hidden terminal. FIG. 2(a) shows this problem. It is possible to mitigate such interference through client feedback, as shown by the (centralized) CFAssign process [4] shows that client feedback in finding interfering APs can mitigate this problem

Using Partially Overlapped Channels. IEEE has divided the 2.4 GHz band into 11 channels. Successive channels are spaced 5 MHz apart while each channel occupies about 44 MHz of bandwidth on either side of the center frequency. This implies that most of the channels overlap in the frequency domain, leaving only channels 1, 6 and 11 as non-overlapping. Recent work in [8] has shown that through careful assignment of channels among interfering APs, it is possible to take advantage of the 11 partially overlapped channels available in the 2.4 GHz band for further throughput gains over the three non-overlapping ones. Here, we summarize the concepts presented in [8] that enable us to extend our channel hopping process to take advantage of partially overlapped channels.

Overlap among channels is captured by the notion of Interference Factor or I-factor for short. Denoted by I(i,j) this indicates the extent of overlap in signal power among the channels i and j. Conceptually, if Pi is the received signal power of a transmission on channel i, then the same receiver would obtain a signal power of Pj=I(i,j)Pi on channel j for the same transmission. I-factor can be computed in a theoretical fashion using expressions for a transmitted signal's power spectral density, or the spread of a signal's power across the frequency domain. It can also be estimated using signal strength measurements as performed in [8].

Obtaining benefit from partially overlapped channels requires explicit interaction and coordination among interfering APs [8]. This is necessary so that partially overlapped channels are assigned carefully to yield throughput gains. In this application, we show that channel hopping can take full advantage of partially overlapped channels in a distributed manner without the need for any coordination between interfering APs.

BASIC CONCEPTS. Uncoordinated wireless deployments exhibit certain important characteristics that affect how we design channel assignment process for them. First, they have high and variable densities. Prior evaluations by [1] based on AP data from Wifimaps.com and Intel's Place Lab have shown that uncoordinated environments exhibit high AP densities especially in urban areas. Also, there is high variation in the densities. Urban deployments have highly dense ‘pockets’ of APs sporadically placed. Second, they are uncoordinated. This implies that channel assignment methods should be distributed. This precludes possibilities such as roaming of clients to different APs [2] and balancing of client load among APs [3]. Finally, since these processes execute at the firmware level on APs they need to be simple and efficient. The application presents the unfairness inherent in static channel assignments when applied to such deployments. The application, then discusses the core concepts of channel hopping and show how it improves fairness among APs.

A. Drawbacks of Static Techniques.

We use the term static assignments to refer to techniques that assign a fixed channel to an AP for a relatively long duration of time (such as hours or days). Such techniques typically model channel assignment as a graph coloring [10] problem and build distributed or centralized process for it. Traditionally, throughput maximization and client-fairness has been the primary goal for such schemes rather than per AP-fairness. Here, we study why-static channel assignment can cause unfairness in uncoordinated environments. Consider the example shown in FIG. 2(b). There are four Aps which interfere with each other and we have three channels to allocate in the 2.4 GHz band. FIG. 2(b) models this as a standard graph coloring problem where the vertices are the set of APs and edges represent interference. We call this the interference graph, defined next:

Definition: A graph G=(V, E) denotes an interference graph when V is the set of APs under consideration and an edge (u,v)εE indicates that APs u and v interfere with each other. Two APs interfere with each other if either the APs interfere directly or clients associated to these APs interfere with each other. Client participation in capturing interference addresses the hidden AP problem discussed earlier. Based on this graph model, static channel assignment becomes a coloring problem. Next, we define the k-colorable property for a graph:

k-coloring property: Given a graph G=(V, E) and a coloring X: V→{1 . . . k} where k is the number of colors used, χ is said to have the k-coloring property iff for each edge e=(u, v)εE, χ(u)=χ(v). For the example of FIG. 2(b), the interference graph is a four-clique as shown. Given that this graph is not three-colorable, a good channel assignment using three colors would attempt to minimize the number of APs that interfere. That is, it would minimize the number of edges e=(u, v)εE such that χ(u)=χ(v). For FIG. 2, there are multiple such assignments possible and two such solutions are shown. The channel numbers are indicated above the APs and in square brackets for the first and the second solution, respectively.

In the first assignment of FIG. 2(b), APs 2 and 3 operate on the same channel. The 802.11 distributed coordination function (DCF) will allow them to share the same channel using MAC level backoffs and the RTSCTS handshakes. However, this happens at the cost of significant reduction in throughput. For simplicity, we assume that 802.11 provides fair sharing of a channel's bandwidth [11]. Based on this, APs 2 and 3 each get ½ of the normalized channel's bandwidth, while APs 1 and 4 get unit bandwidth. Thus, the first solution of FIG. 2(b) performs an unfair assignment to APs 2 and 3 when compared to APs 1 and 4. However, in the second assignment shown in FIG. 2(b) APs 3 and 4 get ½ while APs 1 and 2 get unit band with. From this example, it is apparent that static channel assignments tend to be biased towards a certain set of APs over the others.

This unfairness in optimal static assignments happens only when the interference graph is not k-colorable, where k is the number of available channels. This follows from the fact that when the graph is k-colorable, optimal static assignment finds such a k coloring and each AP gets unit bandwidth, which is optimally fair. When such a graph is not k-colorable, optimal static assignments attempt to minimize the number of edges that use the same color/channel. The very fact that some edges use the same channel for a long duration of time shows that the corresponding APs suffer unfairly when compared to other APs that do not have such edges (or have a lower number of such edges).

Practically, it is hard to find an optimal static coloring. Finding such a k coloring is NP-hard for general graphs and it is even NP-hard to find a constant approximation [12]. Thus, even if a graph is k-colorable, a good static assignment process will probably not find such a coloring. So, much like before, there will be edges that violate the coloring property and the corresponding APs will suffer degraded throughput when compared to others because of sharing the same channel. Thus, even if a graph is k-colorable, as long as the static channel assignment process does not find such a k coloring, there could still be unfairness in the static assignments.

Based on these observations, we ask the following question: How severe will this unfairness be, or in other words, will practical interference graphs not be k-colorable? Considering the dense and uncoordinated nature of hotspot deployments, we expect that the interference graphs representing them will not be k-colorable, for practical values of k (three for 802.11b). Intuitively, this is because the high density in such environments makes these graphs very dense in nature. This increases the number of colors/channels needed for satisfying the k-colorable property. Thus, static channel assignments for most uncoordinated environments will tend to be unfair to some APs over others. Next, we discuss how channel hopping can improve the fairness among APs over such static channel assignments.

B. Channel Hopping

We have seen how static assignment can cause unfairness. In our method of channel assignment, APs use a sequence of channels and transition between them over time. We build channel hopping sequences for APs such that at any time instant, the network as a whole uses a ‘good’ static assignment, like the first assignment shown in FIG. 2(b). But, in order to not cause any one AP to suffer for long, the network switches to a different global assignment, such as the second assignment shown in FIG. 2(b). In this manner, over a long period of time, the throughputs of interfering APs get averaged out to equal values. Below, we discuss this intuition in greater detail.

Basic channel hopping is performed as follows: Time is divided into slots. Let ts denote the duration of a time slot. APs use static channels for the entire duration of a slot. At a slot boundary, APs switch channels to their respective assignments for a subsequent slot. This requires all APs to have a synchronized notion of time and equal slot sizes. We assume that this is the case for ease of exposition. Later in Section V, we relax these constraints for the MAXchop process. The sequence of channels that an AP uses across successive slots defines its channel hopping sequence. The periodicity of a hopping sequence is the number of slots after which the sequence repeats itself.

Consider the example of FIG. 2(b). Suppose, we assign hopping sequences as shown in FIG. 2(c) which utilize three channels: Here, the periodicity of the sequences is six, i.e., the hopping pattern repeats after six slots.

Notation: Let λ denote the hopping sequences. In particular, let A(u) denote the hopping sequence used by AP u. In the above example, λ(AP 1)={1, 2, 2, 3, 2, 2}. Let λᵢ denote the channel assignment for all APs in slot i, (i=1 . . . Ns), where Ns is the periodicity of the hopping sequence. Also, let λᵢ(u) denote the channel used by AP u in slot i. For example, λ₁(AP 1)=1. The hopping sequence shown in FIG. 2(c) has been engineered such that in any fixed slot i, the channel assignment used by the network as a whole, namely λᵢ, attempts to minimize interference in that slot i. In fact, this sequence utilizes one of the optimal channel assignments in each slot. Over the six slots, the network hops between all six possible optimal assignments for the topology of FIG. 2(b). Thus, channel hopping methods allow this flexibility of utilizing multiple different global channel assignments at different time slots. This important property improves the per-AP fairness in throughput.

TABLE I

Slot Number

| AP # | 1 | 2 | 3 | 4 | 5 | 6 | Avg |
|---|---|---|---|---|---|---|---|
| 1 | 1 | 1 | ½ | ½ | 1 | ½ | 0.75 |
| 2 | 1 | ½ | ½ | 1 | ½ | 1 | 0.75 |
| 3 | ½ | ½ | 1 | 1 | 1 | ½ | 0.75 |
| 4 | ½ | 1 | 1 | ½ | ½ | 1 | 0.75 |

Aggregate and Per-Slot Throughput for FIG. 2(b).

Table I shows the normalized throughput obtained by the setup of FIG. 2(b) using the hopping sequence shown in FIG. 2(c). It is evident that in each slot, there is one edge that violates the k-coloring property and the corresponding APs suffer as a result. For example, in slot 1 APs 3 and 4 get ½ the throughput while in slot 3 APs 1 and 2 get ½. Over six slots, each edge would have suffered interference once and each AP twice. At the end of the hopping period, each AP gets equal throughput of ¾. The above example illustrates how channel hopping can improve fairness in uncoordinated and dense environments. This intuition extends to a general graph, as hopping between different ‘good’ channel assignments improves the fairness in the system over each individual assignment.

Security Properties. Although not the focus of this paper, channel hopping techniques have interesting security properties. By making the hopping sequences pseudorandom in nature, it becomes hard for an eavesdropper to predict which channel would be used by an AP next. The clients and APs can use a common pseudo-random generator which can be initialized based on secret keys. This can improve resistance to denial-of-service attacks as the attacker will have to spend considerable time in scanning each channel to find a specific AP. By the time the attacker determines the next channel, the AP would have switched to a subsequent channel. This technique requires a good number of channels, for example, three non-overlapping channels in the 2.4 GHz band might be insufficient. Taking into account the 5 GHz band and the partially overlapped channels available there, this brings the total number of channels to about 56 making it practical. However, since this is not the focus of this paper, we do not investigate this possibility further.

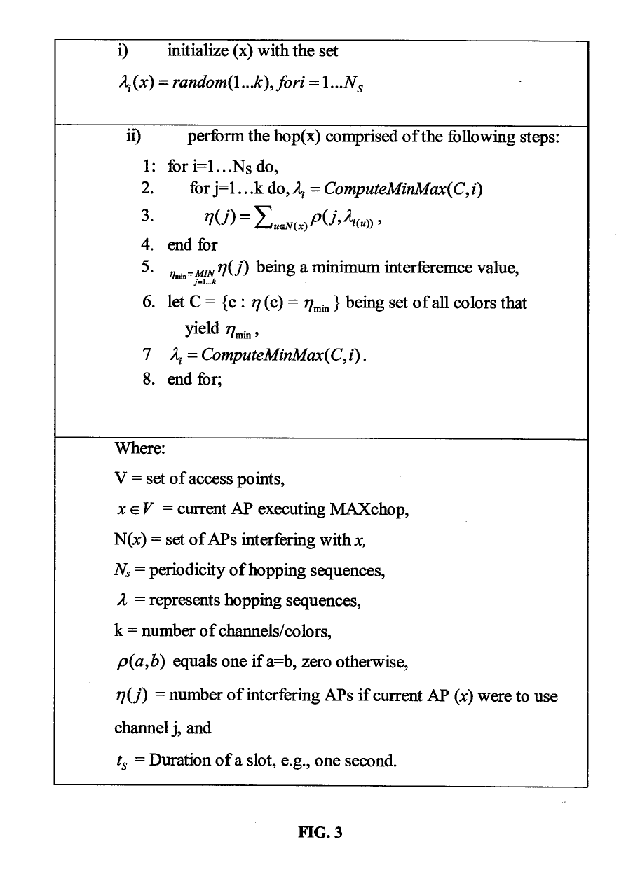

Referring now to FIG. 3, the inventive process, entitled Process 1 MAXchop, uses the concepts of channel hopping along with information about the hopping sequences of interfering APs to build good hopping sequences in a distributed manner. The process does not require any communication among neighboring APs.

At a high level, the process works in a distributed fashion as follows. Each AP first obtains the hopping sequences of other interfering APs. It then computes its hopping sequence that maximizes its throughput. This done for each slot much like the way static channel assignments are computed. That is, for each slot, the AP chooses the channel that minimizes the number of edges which violate the k-coloring property (discussed in Section III) and thus maximizes its throughput. It is possible that multiple channels might yield the same throughput. Now the AP can either (i) select a channel uniformly at random from all such channels, or (ii) it selects the one that distributes interference as evenly as possible among its neighbors. We show that with either approaches the process converges to the same assignment in O(δ) rounds. However, with approach (ii) the convergence rate is faster. Because of space limitations, we describe approach (i) here. A reference process for approach (ii) is presented in the Appendix.

The MAXchop process is shown as Process 1. The process consists of three routines which we discuss below.

Initialize: The Initialize routine is executed at an AP x during bootup, or periodically after a long amount of time, such as on a weekly basis. This is done in order to re-initialize the state maintained by the MAXchop process after a long period of time. This routine initializes the channel assignment with a pseudo-random hopping sequence.

Hop: The second routine, Hop, is executed at the end of a hopping period, that is, after Nsts time duration, where Ns is the hop periodicity and ts is time duration of a single slot. Different APs can have asynchronous time slots and also different slot durations. This information can be exchanged as a part of beacon broadcasts; we discuss such issues later in Section V.

ComputeMinMax: The third routine, ComputeMinMax, computes the color/channel that divides the interference equally among interfering APs, out of a set of colors that provide the best throughput for the given AP x. For ease of exposition in this section, we assume that this routine returns any such color uniformly at random. A reference process for dividing the interference in a min-max fashion is presented in the Appendix.

The functioning of MAXchop is explained through an example below: Lets assume that the Hop function executes on an AP xεV. In Steps 2-4, the Hop function computes the quantity η(j), which measures the number of interfering APs if the current AP x were to use channel j. This is equal to the number of APs uεN(x) such that λᵢ(u)=j, where N(x) is the set of APs interfering with x, and i is the current slot under consideration. Step 5, computes the minimum value of η as ηmin over all colors 1 . . . k for that slot for AP x. Step 6 computes the set C of all colors that yield the minimum value of ηmin. As discussed before, at this point, the AP can either choose a color randomly out of set C or it could do it in a manner that divides the interference equally among neighboring APs. We discuss the second possibility in detail next. Step 7 calls the function ComputeMinMax that returns a color from C such that it distributes the interference equally among all neighbors of x (see Appendix). For simplicity, we assume that it returns any color from C uniformly at random.

Convergence. Each AP executes the MAXchop process periodically at the end of every hop cycle. Even with this periodic execution, we say that MAXchop has converged if the APs uses the same hopping sequence in successive hop cycles. This assumes that the network dynamics such as client associations, ambient noise levels stay constant over this period. Convergence properties of distributed process show a definitive direction towards which the network is evolving itself and thus assume significant importance. We argue convergence for MAXchop based on the following invariant: Let \tilde{L}E denote the L-values of all edges arranged in non-decreasing order.

Invariant: Consider an AP x that is about to execute the Hop function in the MAXchop Process. Let pr\tilde{e}L_{E} denote the value of \tilde{L}_{E} before execution of the Hop function. Let po\tilde{s}tL_{E} denote the value of \tilde{L}_{E} after execution of Hop at the AP x. Then, pr\tilde{e}L_{E}≧lex po\tilde{s}tL_{E}. This inequality follows from observing that Hop alters the value of \tilde{L}_{E} in the following manner: by considering only those colors that yield minimum interference of ηmin in Step 6, Hop minimizes the sum of all L-values. That is, Steps 2-6 compute

$${MIN}_{j = 1 … k} {\sum }_{∀ u ∈ N ( x )} ρ ( {λ}_{i} ( u ) , k ) .$$

A more detailed proof of this convergence is sketched in the Appendix section at the end of the application, before the claims.

B. Utilizing Partially Overlapped Channels. In this section of the application, we discuss how channel hopping can take advantage of partially overlapped channels without requiring explicitly interaction among interfering APs.

The MAXchop process requires minor modifications to incorporate partially overlapped channels. Recall that Step 3 in the Hop routine of Process 1 calculates the η function for the current AP x as follows: η(j)=Σ_{uεN(x)}ρ(j,λᵢ(u)). For slot i assuming AP x were to use channel j, this function determines the number of APs uεN(x) that would interfere with AP x. With non-overlapping channels, this is calculated by the p function which states that they interfere iff both APs use the same channel.

We modify the ρ function to capture interference from a partially overlapped channel as follows. Specifically, define ρ(u, i, x, j) to indicate if AP u on channel i interferes with AP x on channel j. If Px(u) denotes the received power of a transmission from AP u received at AP x assuming both are on the same channel, then Px(u)I(i,j) denotes the received power for the same transmission if the transmitter was on channel i and the receiver was on channel j. Based on this, we construct the p function by requiring that this received power should be above a certain threshold to cause interference. Clearly, this is a binary interference model. However, this is not a limitation of the MAXchop process. The ρ function can be readily replaced with a more realistic interference model such as the following ρ(u, i, x, j)=Px(u)I(i,j). This model gives the exact amount of signal from AP u that would interfere at AP x. With these modifications, the semantics of Step 5 which uses p still stays the same and all other properties of the process continue to hold. In the next Section, we discuss the practical considerations in implementing MAXchop.

PRACTICAL CONSIDERATIONS. Turning now to a discussion of the practical issues with implementing MAXchop in an uncoordinated wireless environment over off-the-shelf commodity hardware.

Implementing Channel Switching. Implementing channel switching brings up two important issues which we discuss below.

(i) Client-AP Coordination: First, an AP has to inform all its associated clients to move to a different channel. This can be implemented as a special beacon message. Implementing it as a part of the beacon message provides the following properties. The beacon is sent periodically and at the lowest bit-rate supported by the AP. This maximizes the probability that all associated clients receive the beacon. Also, clients in power-save mode wake up to receive beacon messages. In this manner, such clients will also be aware of channel changes. Such constructs are already in place in the upcoming IEEE 802.11k draft standard on Radio Resource Management. Also, much like the way channel information is available in a beacon message today, the exact hopping sequence computed by an AP can be included as well. This allows the neighboring interfering APs to obtain each other's hopping sequence for executing MAXchop. In our implementation discussed in Section VII, we use dedicated broadcast messages to trigger channel changes.
(ii) Channel Switch Overhead: Second, we measured the channel switch latency for some of the popular 802.11 vendors. We instrumented open source drivers in GNU/Linux for the following cards, and measured the channel switch latencies in the drivers:

| Vendor | Chipset | Type | Driver | latency |
|---|---|---|---|---|
| ZoomAir | Prism 2.5 | 802.11b | hostap | 20 ms |
| Cisco | Aironet | 802.11b | Airo_vcs | 10 ms |
| Netgear | Atheros | 802.11 a/b/g | Madwifi | 6 ms |
| Intel | Intel | 802.11 b/g | Ipw | 200 μs |

Although newer chipsets such as the Intel's ProWireless provide low channel switch latencies, for most others the latency is high enough to trigger packet delays and potential losses. In Sections VI and VII, we study the impact of these on TCP through testbed experiments and simulations. We provision our channel hopping process to perform the following: First, trigger channel switch is triggered during low periods of activity. This minimizes such losses. Second, the slot duration is chosen to be sufficiently large enough (such as one second or more) such that the overhead of switching channels gets amortized over an entire slot. Finally, considering the other significant gains obtained by channel hopping, this overhead becomes relatively small.

Estimating the APs that interfere. The MAXchop process requires information on the hopping sequences of interfering APs. This can be implemented in two ways, namely, client-driven and AP-driven. Prior work by Mishra et. al. [4] has shown that client-driven estimation of interfering APs is crucial to find what are called hidden APs. We have discussed this briefly in Section II. Our MAXchop process takes as input the set of APs that interfere and their hopping sequences. Thus, both approaches can be implemented with the MAXchop process. In the client-driven approach APs request associated clients to perform a scan of all channels and report interfering APs (and their hopping sequences). Also, APs themselves perform a scan to find interfering APs. Constructs to implement client-driven scanning have been included in the IEEE 802.11k draft. In the AP-driven approach, only APs perform this scan and collect necessary information. These scan operations are performed with relatively low periodicity (such as once per 30 minutes) since AP positions and topologies do not change frequently. In our evaluation presented in Section VI, we contrast both methods.

Asynchrony in Hopping: Different APs can have different periodicity in their hopping sequences. Also their time slots need not be aligned. This removes the need for any explicit synchronization between APs and also allows them to switch channel opportunistically (during low periods of activity). The MAXchop process takes care of this as follows. The hopping patterns of an interfering AP can be transformed to best match the current APs hop cycle such that interference calculations can be performed (Step 3 of Process 1). In an evaluation through simulations and a testbed based implementation, APs have an asynchronous notion of time, and thus their slot updates are not synchronized. We find that over a long period of time, MAXchop with asynchronous slots performs the same as with synchronization.

In summary, based on good fairness properties of channel hopping for uncoordinated wireless environments, the inventive process hops between good static channel assignments and also utilizes partially overlapped channels. The inventive process operates in a fully distributed fashion and it converges provably and rapidly. The inventive channel hopping is a simple and efficient method of distributed channel assignment that provides good fairness properties and is also able to take full advantage of partially overlapped channels for the much needed throughput gains in such dense networks.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which, although not explicitly shown or described herein, embody the principles of the invention and are within their spirit and scope.

### APPENDIX

In this appendix, proof of convergence is sketched for the inventive process, MAXchop, within O(δ) rounds where δ is the average degree of an AP in the interference graph (δ=|E|/|V|). Consider Hop routine shown for the process MAXchop. Assuming that the current AP x was using color λᵢ(x) in slot i prior to executing Hop, the amount of interference for slot i was η(λᵢ(x)). After executing steps 2-5 of the function Hop, the new interference value equals ηₘᵢₙ and let \tilde{λ}ᵢ(x) denote the new color obtained in step 7. Thus, since λᵢ(x)εC:η(\tilde{λ}ᵢ(x))≦η(λᵢ(x)).

Note that the above inequality holds even if step 7 were to choose any random color out of the set C. Consider L_{SUM=Σ}_{_{∀(u,v)εE}}_{L(u,v)}, the sum of all L-values, where L(u,v)=Σᵢ₌1 . . . N_{_{S}}ρ(λᵢ(u),λᵢ(v)). Now L_{SUM} can be expanded as

$${L}_{SUM} = \frac{1}{2} {\sum }_{v ∈ V} {\sum }_{u ∈ N ( v )} {\sum }_{i = 1 … {N}_{S}} ρ ( {λ}_{i} ( u ) , {λ}_{i} ( v ) ) .$$

Rearranging the summations,

$${L}_{SUM} = \frac{1}{2} {\sum }_{v ∈ V} {\sum }_{i = 1 … {N}_{S}}^{ } {η}^{v} ( {λ}_{i} ( v ) ) .$$

Let \tilde{L}_{SUM} denote the value of L_{SUM} after node x executed HOP function. Thus,

$${\tilde{L}}_{SUM} = \frac{1}{2} {\sum }_{v ∈ V} {\sum }_{i = 1 … {N}_{S}} {η}^{v} ( {\tilde{λ}}_{i} ( v ) ) .$$

### Now

$${\tilde{L}}_{SUM} - {L}_{SUM} = \frac{1}{2} {\sum }_{i = 1 … {N}_{S}} [ {η}^{v} ( {\tilde{λ}}_{i} ( v ) ) - {η}^{v} ( {λ}_{i} ( v ) ) ] .$$

It follows that, \tilde{L}_{SUM}−L_{SUM}≦0 as η^{v}(\tilde{λ}ᵢ(v))≦η^{v}(λᵢ(v)). Or \tilde{L}_{SUM}≦L_{SUM}.

Since L-value is the number of interfering edges in the network as a whole. This is integral and has a minimum. Also L_{SUM}≦|E|. This proves convergence in O(δ) rounds, where δ=|E|/|V|.

Below is presented a reference process for the ComputeMinMax routine discussed in the application.

Procedure ComputeMinMax(C,i)

```
  1: if i=1 then
  2: return a color from C uniformly at random
  3: end if
  4: Compute: ∀u ∈ N(x),L(u) = Σ_{j=1...i-1}ρ(λⱼ(u),λⱼ(x)).
  5: Compute: ∀c ∈ C,L_{c}(u) = L(u) + ρ(c,λᵢ(u)).
  6: Define: ∀c ∈ C,\tilde{L}_{c} = <(L_{C}(u)> over all u ∈ N(x) sorted in
non-increasing order L_{C} value.
  7: Let \tilde{L}ₘᵢₙ = \tilde{L}_{α},Cₘᵢₙ = α for a random α ∈ C.
  8: for c ∈ C do
  9: if \tilde{L}_{MIN} is greater than ₗₑₓL_{c} then
  10: \tilde{L}_{MIN=}\tilde{L}_{c} and C_{MIN=c}
  11: end if
  12: end for
  13: return Cₘᵢₙ
```

What is claimed is:

1. A method, comprising the steps of:
i) obtaining first for each AP hopping sequences of other interfering APs; and
ii) determining for said each AP a respective hopping sequence that maximizes said each APs throughput.

2. The method of claim 1, wherein said step of determining comprises for each slot said AP choosing a channel that minimizes the number of edges which violate a k-coloring property.

3. The method of claim 1, further comprising the step of said AP selecting one of (a) a channel uniformly at random from all such channels and (b) selecting a channel that distributes interference evenly as possible among neighboring APs.

4. A method comprising the steps of
i) initializing channel assignment with a pseudo-random hopping sequence;
ii) determining interferences between APs for each said channel assignment, and
iii) determining a color/channel that divides interferences equally among interfering APs out of a set of colors that provide best throughput for a given AP.

5. The method of claim 4, wherein said step i) initializing is executed at an AP during one of bootup and periodically after a given period of time.

6. The method of claim 4, wherein said step i) initializing comprises re-intializing the state maintained by said method after a given period of time.

7. The method of claim 4, wherein said step ii) determining comprises being done at the end of a hopping period.

8. The method of claim 4, wherein said step ii) determining comprises being done after Nₛ tₛ time duration, where Nₛ is the hop periodicity and tₛ is time duration of a single slot.

9. A method for comprising the steps of:
i) initialize (x) with the set λᵢ(x)=random(1 . . . k), for i=1 . . . N_{S}
ii) perform the hop(x) routine comprised of the following steps:

| | |
|---|---|
| 1: | for i=1 . . . Nₛ do, |
| 2. | for j=1 . . . k do, λᵢ = ComputeMinMax(C, i) |
| 3. | η(j) = Σ_{u∈N (x)}ρ(j, λᵢ₍ᵤ₎₎, |
| 4. | end for |
| 5. | ${ }_{{}_{{η}_{min} = {MIN}_{j = 1 …k}} η ( j )}$ being a minimum interferemce value, |
| 6. | let C = {c :η(c) = ηₘᵢₙ} being set of all colors that yield ηₘᵢₙ, |
| 7. | λᵢ = ComputeMinMax(C, i). |
| 8. | end for; |

Where V is set of access points, xεV is current AP executing MAXchop, N(x) is set of APs interfering with x, Nₛ is periodicity of hopping sequences, λ represents hopping sequences, k is number of channels/colors, ρ(a,b) equals one if a=b, zero otherwise, η(j) is number of interfering APs if current AP (x) were to use channel j, and t_{S} is duration of a slot.
